(19) United States
(12) Patent Application Publication
(10) Pub. No.: US 2014/0144236 A1
(43) Pub. Date: May 29, 2014

(54) ACCELERATION SENSOR

(71) Applicant: SAMSUNG ELECTRO-MECHANICS CO., LTD., Suwon (KR)

(72) Inventors: Chang Hyun Lim, Suwon (KR); Seung Hun Han, Suwon (KR); Jung Won Lee, Suwon (KR); Sung Jun Lee, Suwon (KR); Jeong Suong Yang, Suwon (KR)

(73) Assignee: SAMSUNG ELECTRO-MECHANICS CO., LTD., Suwon (KR)

(21) Appl. No.: 13/845,094

(22) Filed: Mar. 18, 2013

(30) Foreign Application Priority Data
Nov. 23, 2012 (KR) 10-2012-0133840

(51) Int. Cl. G01P 15/18

(52) U.S. Cl. CPC G01P 15/18
USPC 73/514.33

(57) ABSTRACT

Disclosed herein is an accelerator sensor, including: a mass body; a flexible beam that is provided with a piezoresistive element configured of an X-axis resistive element, a Y-axis resistive element, and a Z-axis resistive element having both ends connected with contact pads and is connected with the mass body; and a support portion that is connected with the flexible beam and supports the flexible beam so as to float the mass body, wherein the flexible beam has a slit provided between one-axis resistive element and the other axis resistive element adjacent to each other and the slit is extendedly formed from the contact pads connected with ends of the one axis resistive element and the other axis resistive element to the contact pads connected with the other ends thereof.

### CROSS REFERENCE TO RELATED APPLICATION

This application claims the benefit of Korean Patent Application No. 10-2012-0133840, filed on Nov. 23, 2012, entitled “Acceleration Sensor” which is hereby incorporated by reference in its entirety into this application.

### BACKGROUND OF THE INVENTION

1. Technical Field

The present invention relates to an acceleration sensor.

2. Description of the Related Art

Generally, an acceleration sensor has been variously used for a car, an airplane, a mobile communication terminal, a toy, and the like. Meanwhile, a high-performance and small tri-axial acceleration sensor capable of measuring an X axis, a Y axis, and a Z axis has been developed so as to measure fine acceleration.

Further, the acceleration sensor according to the related art has technical features of converting a motion of a mass body and a flexible portion into an electrical signal and uses a piezoresistive type that detects a motion of a mass body using a change in resistance of a piezoresistive element disposed in a flexible portion, a capacitive type that detects a motion of a mass body using a change in capacitance between fixed electrodes, and the like.

Here, the piezoresistive type uses an element of which the resistance value is changed due to stress and, for example, increases a resistance value at a place where tensile stress is distributed and reduces a resistance value at a place where a compressive stress is distributed.

However, the acceleration sensor based on the piezoresistive type according to the related art including the following Citation List has direction dependency since acceleration is a vector quantity, such that the acceleration sensor has a problem in that other-axis sensitivity appears. That is, the acceleration sensor based on the piezoresistive type may be difficult to accurately and efficiently sense acceleration and may generate short between resistors due to an effect of two axis components other than a required axis among three components of X, Y, and Z.

### RELATED ART DOCUMENT

### Patent Document

(Patent Document 1) US 20060156818 A

### SUMMARY OF THE INVENTION

The present invention has been made in an effort to provide an acceleration sensor capable of improving sensitivity by having slits provided between piezoresistive elements disposed on a beam, preventing short from being generated between contact pads by extending the slits to the contact pads of the piezoresistive elements, and improving a stress concentration effect by additionally forming notches in the slits.

According to a preferred embodiment of the present invention, there is provided an acceleration sensor, including: a mass body; a flexible beam that is provided with a piezoresistive element configured of an X-axis resistive element, a Y-axis resistive element, and a Z-axis resistive element having both ends connected with contact pads and is connected with the mass body; and a support portion that is connected with the flexible beam and supports the flexible beam so as to float the mass body, wherein the flexible beam has a slit provided between one-axis resistive element and the other axis resistive element adjacent to each other and the slit is extendedly formed from the contact pads connected with ends of the one axis resistive element and the other axis resistive element to the contact pads connected with the other ends thereof.

The flexible beam may be configured of a first flexible beam, a second flexible beam, a third flexible beam, and a fourth flexible beam that are connected with all sides of the mass body at an equal distance, and the first flexible beam and the second flexible beam may be disposed to face each other based on the mass body and the third flexible beam and the fourth flexible beam may be disposed so as to face each other based on the mass body.

The first flexible beam and the second flexible beam may be provided with the X-axis resistive element and the Z-axis resistive element and the third flexible beam and the fourth flexible beam may be provided with the Y-axis resistive element.

A width center of the first flexible beam that is an orthogonal direction to a direction in which the support portion is connected with the mass body may be provided with the X-axis resistive element and a width edge of the first flexible beam may be provided with the Z-axis resistive element so as to be parallel with the X-axis resistive element, and a width center of the second flexible beam that is an orthogonal direction to a direction in which the support portion is connected with the mass body may be provided with the X-axis resistive element and a width edge of the second flexible beam may be provided with the Z-axis resistive element so as to be parallel with the X-axis resistive element.

The first and second flexible beams may have a first slit provided between the X-axis resistive element and the Z-axis resistive element and has a second slit provided at an opposite side of the X-axis resistive element with respect to the first slit and a third slit at an opposite side of the Z-axis resistive element with respect to the first slit.

The first slit may be provided with notches each protruded so as to be opposite to the X-axis resistive element and the Z-axis resistive element.

The second slit may be provided with a notch protruded so as to be opposite to the X-axis resistive element.

The third slit may be provided with a notch protruded so as to be opposite to the Z-axis resistive element.

The Z-axis resistive elements formed on the first flexible beam and the second flexible beam may be disposed at one side on one beam and the other side on another beam, based on the X-axis resistive element.

According to another preferred embodiment of the present invention, there is provided an acceleration sensor, including: a mass body; a flexible beam that is provided with a piezoresistive element configured of an X-axis resistive element, a Y-axis resistive element, and a Z-axis resistive element having both ends connected with contact pads and is connected with the mass body; and a support portion that is connected with the flexible beam and supports the flexible beam so as to float the mass body, wherein the flexible beam has slits provided between one axis resistive element and the other axis resistive element that are adjacent to each other and the slit is provided between a contact pad of the one axis resistive element and a contact pad of the other axis resistive element opposite to the one axis resistive element.

The flexible beam may be configured of a first flexible beam, a second flexible beam, a third flexible beam, and a fourth flexible beam that are connected with all sides of the mass body at an equal distance and the first flexible beam and the second flexible beam may be disposed to face each other based on the mass body and the third flexible beam and the fourth flexible beam are disposed so as to face each other based on the mass body.

The first flexible beam and the second flexible beam may be provided with the X-axis resistive element and the Z-axis resistive element and the third flexible beam and the fourth flexible beam may be provided with the Y-axis resistive element.

A width center of the first flexible beam that is an orthogonal direction to a direction in which the support portion is connected with the mass body may be provided with the X-axis resistive element and a width edge of the first flexible beam may be provided with the Z-axis resistive element so as to be parallel with the X-axis resistive element and a width center of the second flexible beam that is an orthogonal direction to a direction in which the support portion is connected with the mass body may be provided with the X-axis resistive element and a width edge of the second flexible beam may be provided with the Z-axis resistive element so as to be parallel with the X-axis resistive element.

The Z-axis resistive elements formed on the first flexible beam and the second flexible beam may be disposed at one side on one beam and the other side on another beam, based on the X-axis resistive element.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram schematically illustrating an acceleration sensor according to a preferred embodiment of the present invention;

FIG. 2 is a partial configuration diagram schematically illustrating an acceleration sensor according to another preferred embodiment of the present invention; and

FIG. 3 is a partial configuration diagram schematically illustrating an acceleration sensor according to still another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention are described in detail with reference to the accompanying drawings.

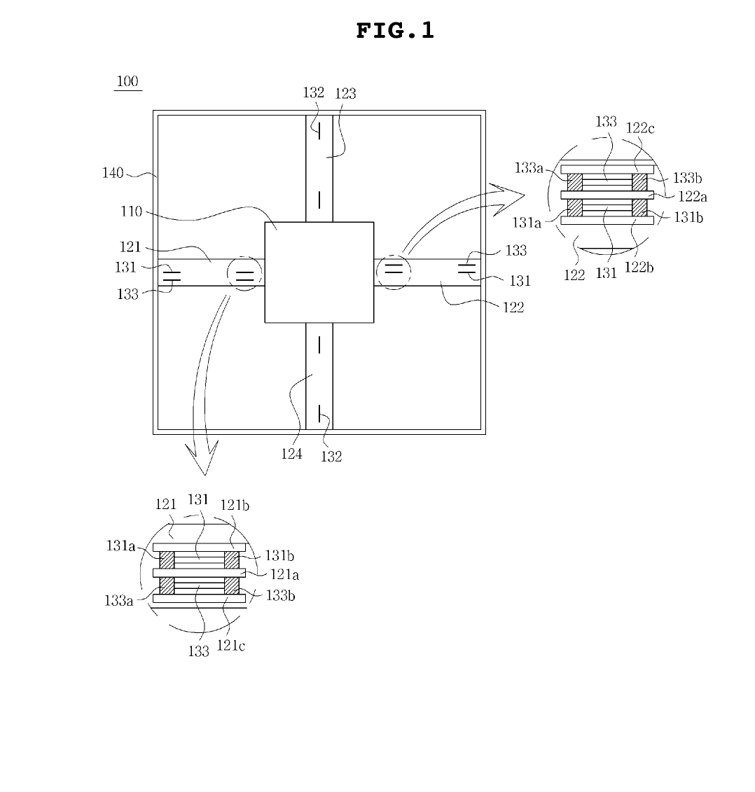

FIG. 1 is a configuration diagram schematically illustrating an acceleration sensor according to a preferred embodiment of the present invention. As illustrated in FIG. 1, an acceleration sensor 100 is a tri-axial piezoresistive acceleration sensor and includes a mass body 110, a flexible beam 120, a piezoresistive element (resistor) 130, and a support portion 140.

In more detail, when external force is generated, the mass body 110 moves due to a moment generated by the external force and a resistance value of the piezoresistive element 130 of the flexible beam 120 formed of a flexible substrate is changed due to a displacement of the mass body 110.

To this end, the mass body 110 is connected with the flexible beam 120, the piezoresistive element is disposed on the flexible beam 120, and the support portion 140 is connected with the flexible beam 120 to support the flexible beam 120 so as to float the mass body 110.

Further, the flexible beam 120 is configured of a first flexible beam 121, a second flexible beam 122, a third flexible beam 123, and a fourth flexible beam 124 that are each connected with all sides of the mass body 110 at an equal distance. Further, the first flexible beam 121 and the second flexible beam 122 are disposed to face each other based on the mass body 110 and the third flexible beam 123 and the fourth flexible beam 124 are disposed to face each other based on the mass body 110.

In addition, the piezoresistive element includes an X-axis resistive element 131, a Y-axis resistive element 132, and a Z-axis resistive element 133.

In more detail, the first flexible beam 121 and the second flexible beam 122 are provided with the X-axis resistive element 131 and the Z-axis resistive element 133 and the third flexible beam 123 and the fourth flexible beam 124 are provided with the Y-axis resistive element 132.

In addition, a width center of the first flexible beam 121 that is an orthogonal direction to a direction in which the support portion is connected with the mass body is provided with the X-axis resistive element 131 and a width edge of the first flexible beam is provided with a Z-axis resistive element 133 so as to be parallel with the X-axis resistive element 131. That is, the first flexible beam 121 is provided with two pairs of X-axis resistive elements 131 and Z-axis resistive elements 133 that are parallel with each other.

In addition, a width center of the second flexible beam 122 that is an orthogonal direction to a direction in which the support portion is connected with the mass body is provided with the X-axis resistive element 131 and a width edge of the second flexible beam is provided with a Z-axis resistive element 133 so as to be parallel with the X-axis resistive element 131. That is, the second flexible beam 122 is provided with two pairs of X-axis resistive elements 131 and Z-axis resistive elements 133 that are parallel with each other.

Further, in connection with the Z-axis resistive elements 133 disposed on the first flexible beam 121 and the second flexible beam 122 that are disposed so as to face each other based on the mass body 110, the Z-axis resistive element 133 is disposed at one side on one beam and is disposed at the other side on another beam, based on the X-axis resistive element 131.

Further, the first and second flexible beams 121 and 122 of the acceleration sensor according to the preferred embodiment of the present invention are each provided with slits 121a, 121b, 121c, 122a, 122b, and 122c so as to prevent short and crosstalk of the X-axis resistive element 131 and the Z-axis resistive element 133 that are adjacent to each other and improve sensitivity.

Further, one end and the other end of the X-axis resistive element 131 and the Z-axis resistive element 133 are each connected with contact pads 131a, 131b, 133a, and 133b.

That is, one end of the X-axis resistive element 131 is connected with a contact pad 131a of the first X-axis resistive element and the other end thereof is connected with a contact pad 131b of the second X-axis resistive element and one end of the Z-axis resistive element 133 is connected with a contact pad 133a of the first Z-axis resistive element and the other end thereof is connected with a contact pad 133b of the second Z-axis resistive element.

In addition, the slits 121a, 121b, and 121c are formed to extend over the contact pad 131b of the second X-axis resistive element from the contact pad 131a of the first X-axis resistive element and the contact pad 133b of the second Z-axis resistive element from the contact pad 133a of the first Z-axis resistive element.

Further, the slits 121a, 121b, 121c, 122a, 122b, and 122c are configured of the first slits 121a and 122a, the second slits 121b and 122b, and the third slits 121c and 122c and the first slits 121a and 122a are formed between the X-axis resistive element 131 and the Z-axis resistive element 133, the second slits 121b and 122b are formed at an opposite side of the X-axis resistive element 131 with respect to the first slits 121a and 122a, and the third slits 121c and 122c are formed at an opposite side of the Z-axis resistive element 133 with respect to the first slits 121a and 122a.

Next, the third flexible beam 123 is provided with two Y-axis resistive elements 132 toward the support portion 140 from an adjacent portion of the mass body 110.

Further, the Y-axis resistive elements 132 are disposed, in a row, at the width center of the flexible beam that is an orthogonal direction to the direction in which the support portion 140 is connected with the mass body 110.

Further, like the third flexible beam 123, the fourth flexible beam 124 is provided with two Y-axis resistive elements 132 that are toward the support portion 140 from an adjacent portion of the mass body 110 and are disposed, in a row, at the width center of the flexible beam that is an orthogonal direction to the direction in which the support portion 140 is connected with the mass body 110.

In addition to this, the third flexible beam 123 and the fourth flexible beam 124 are provided with the Y-axis resistive elements 132 that are symmetrical with each other based on the mass body 110.

As described above, the acceleration sensor according to the preferred embodiment of the present invention has the slits provided between the X-axis resistive element and the Z-axis resistive element that are the piezoresistive elements on the flexible beams and at the other side opposite thereto, thereby improving the sensitivity and preventing the short of the contact pads.

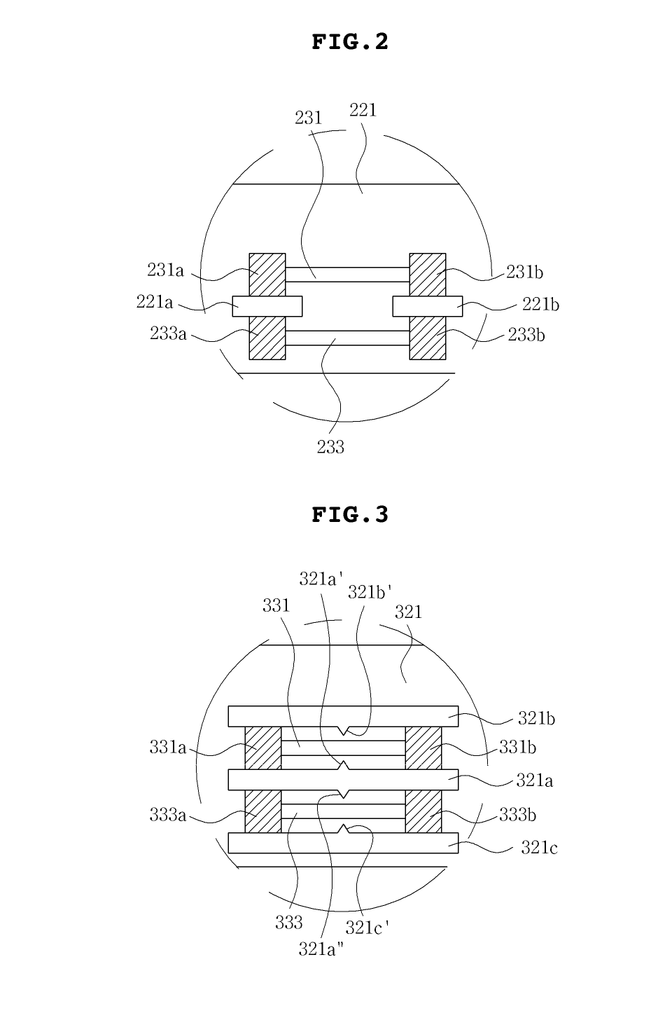

FIG. 2 is a partial configuration diagram schematically illustrating an acceleration sensor according to another preferred embodiment of the present invention. As illustrated, the acceleration sensor according to another preferred embodiment of the present invention is different from the acceleration sensor according to the preferred embodiment illustrated in FIG. 1, in terms of only the formation position and the size of the slit. That is, the acceleration sensor according to another preferred embodiment of the present invention has slits provided at an adjacent portion of the pad portion between different axis piezoresistive elements.

In more detail, a width center of a first flexible beam 221 that is an orthogonal direction to a direction in which the support portion is connected with the mass body is provided with an X-axis resistive element 231 and a width edge of the first flexible beam 221 is provided with a Z-axis resistive element 233 so as to be parallel with the X-axis resistive element 231. That is, the first flexible beam 221 is provided with two pairs of X-axis resistive elements 231 and Z-axis resistive elements 233 that are parallel with each other.

Further, the third flexible beam and the fourth flexible beam and the X-axis and Y-axis resistive elements and the Z-axis resistive element disposed thereon are implemented so as to be the same as the acceleration sensor according to the preferred embodiment illustrated in FIG. 1, and therefore the overlapping description thereof will be omitted.

Further, the piezoresistive element according to another preferred embodiment of the present invention has slits provided between the contact pads connected with other axis resistive elements so as to prevent the short and crosstalk of the other axis resistive elements adjacent to each other and improve the sensitivity.

In more detail, one end and the other end of the X-axis resistive element 231 and the Z-axis resistive element 233 are each connected with contact pads 231a, 231b, 233a, and 233b.

That is, one end of the X-axis resistive element 231 is connected with a contact pad 231a of the first X-axis resistive element and the other end thereof is connected with a contact pad 231b of the second X-axis resistive element and one end of the Z-axis resistive element 233 is connected with a contact pad 233a of the first Z-axis resistive element and the other end thereof is connected with a contact pad 233b of the second Z-axis resistive element.

Further, the contact pad 233a of the first Z-axis resistive element is disposed to face the contact pad 231a of the first X-axis resistive element and the contact pad 233b of the second Z-axis resistive element is disposed to face the contact pad 231b of the second X-axis resistive element.

In addition, the slits 221 and 221b are configured of the first slit 221a and the second slit 221b and the first slit 221a is disposed between the contact pad 231a of the first resistive element and the contact pad 233a of the first Z-axis resistive element and the second slit 221b is disposed between the contact pad 231b of the second X-axis resistive element and the contact pad 233b of the second Z-axis resistive element.

In addition, the first slit 221a and the second slit 221b may be more extendedly formed than the contact pads 231a, 233a, 231b, and 233b opposite thereto.

Further, the piezoresistive element according to another preferred embodiment of the present invention has the slits provided between the contact pads even in the X-axis resistive element and the Z-axis resistive element that are disposed on the second flexible beam and is implemented to be the same as the foregoing first flexible beam, therefore the detailed description thereof will be omitted.

According to the configuration as described above, the piezoresistive element according to another preferred embodiment of the present invention has the slits oppositely provided only in the contact pads of different axis resistive elements, thereby improving a problem in that the beam width is increased due to a diffusion length.

FIG. 3 is a partial configuration diagram schematically illustrating an acceleration sensor according to still another preferred embodiment of the present invention. As illustrated, the acceleration sensor according to still another preferred embodiment of the present invention is different from the acceleration sensor according to the preferred embodiment illustrated in FIG. 1, in terms of only the shape of the slit. That is, the acceleration sensor according to still another embodiment of the present invention has notches further provided in the slits that are formed on the flexible beams.

In more detail, a width center of a first flexible beam 321 that is an orthogonal direction to a direction in which the support portion is connected with the mass body is provided with an X-axis resistive element 331 and a width edge of the first flexible beam 321 is provided with a Z-axis resistive element 331 so as to be parallel with the X-axis resistive element 333. That is, the first flexible beam 321 is provided with two pairs of X-axis resistive elements 331 and Z-axis resistive elements 333 that are parallel with each other.

Further, the third flexible beam and the fourth flexible beam and the X-axis and Y-axis resistive elements and the Z-axis resistive element disposed thereon are implemented so as to be the same as the acceleration sensor according to the preferred embodiment illustrated in FIG. 1, and therefore the overlapping description thereof will be omitted.

Further, the piezoresistive element according to another preferred embodiment of the present invention has slits provided between the contact pads connected with the other axis resistive element so as to prevent the short and crosstalk of the other axis resistive element adjacent to each other and improve the sensitivity.

In addition, the slits 321a, 321b, and 321c are each provided so as to prevent the short and crosstalk of the X-axis resistive element 331 and the Z-axis resistive element 333 and improve the sensitivity.

Further, one end and the other end of the X-axis resistive element 331 and the Z-axis resistive element 333 are each connected with contact pads 331a, 331b, 333a, and 333b.

That is, one end of the X-axis resistive element 331 is connected with the contact pad 331a of the first X-axis resistive element and the other end thereof is connected with the contact pad 331b of the second X-axis resistive element and one end of the Z-axis resistive element 333 is connected with the contact pad 333a of the first Z-axis resistive element and the other end thereof is connected with the contact pad 333b of the second Z-axis resistive element.

In addition, the slits 321a, 321b, and 321c are formed to extend over the contact pad 331b of the second X-axis resistive element from the contact pad 331a of the first X-axis resistive element and the contact pad 333b of the second Z-axis resistive element from the contact pad 333a of the first Z-axis resistive element.

Further, the slits 321a, 321b, and 321c are configured of the first slits 321a, the second slit 321b, and the third slit 321c, the first slit 321a is formed between the X-axis resistive element 331 and the Z-axis resistive element 333, the second slit 321b is formed at an opposite side of the X-axis resistive element 331 with respect to the first slit 321a, and the third slit 321c is formed at an opposite side of the Z-axis resistive element 333 with respect to the first slit 121a.

In addition, the first slit 321a is provided with notches 321a′ and 321a″ that are each protruded so as to be opposite to the X-axis resistive element 331 and the Z-axis resistive element 333.

Further, the second slit 321b is provided with a notch 321b′ that is protruded to be opposite to the X-axis resistive element 331.

Further, the third slit 321c is provided with a notch 312c′ that is protruded to be opposite to the Z-axis resistive element 333.

Further, the acceleration sensor according to still another preferred embodiment of the present invention has the slits provided even in the X-axis resistive element and the Z-axis resistive element that are disposed on the second flexible beam and is implemented to be the same as the foregoing first flexible beam, therefore the detailed description thereof will be omitted.

According to the configuration as described above, the acceleration sensor according to still another preferred embodiment of the present invention is provided with the notches in addition to the slits, thereby implementing more effective stress concentration.

According to the preferred embodiments of the present invention, it is possible to obtain the acceleration sensor capable of improving sensitivity by having the slits provided between the piezoresistive elements disposed on the beam, preventing the short from being generated between the contact pads by extending the slits to the contact pads of the piezoresistive elements, and improving the stress concentration effect by additionally forming the notches in the slits.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An acceleration sensor, comprising:
a mass body;
a flexible beam that is provided with a piezoresistive element configured of an X-axis resistive element, a Y-axis resistive element, and a Z-axis resistive element having both ends connected with contact pads and is connected with the mass body; and
a support portion that is connected with the flexible beam and supports the flexible beam so as to float the mass body,
wherein the flexible beam has a slit provided between one-axis resistive element and the other axis resistive element adjacent to each other and the slit is extendedly formed from the contact pads connected with ends of the one axis resistive element and the other axis resistive element to the contact pads connected with the other ends thereof.

2. The acceleration sensor as set forth in claim 1, wherein the flexible beam is configured of a first flexible beam, a second flexible beam, a third flexible beam, and a fourth flexible beam that are connected with all sides of the mass body at an equal distance, and
the first flexible beam and the second flexible beam are disposed to face each other based on the mass body and the third flexible beam and the fourth flexible beam are disposed so as to face each other based on the mass body.

3. The acceleration sensor as set forth in claim 2, wherein the first flexible beam and the second flexible beam are provided with the X-axis resistive element and the Z-axis resistive element and the third flexible beam and the fourth flexible beam are provided with the Y-axis resistive element.

4. The acceleration sensor as set forth in claim 3, wherein a width center of the first flexible beam that is an orthogonal direction to a direction in which the support portion is connected with the mass body is provided with the X-axis resistive element and a width edge of the first flexible beam is provided with the Z-axis resistive element so as to be parallel with the X-axis resistive element, and
a width center of the second flexible beam that is an orthogonal direction to a direction in which the support portion is connected with the mass body is provided with the X-axis resistive element and a width edge of the second flexible beam is provided with the Z-axis resistive element so as to be parallel with the X-axis resistive element.

5. The acceleration sensor as set forth in claim 4, wherein the first and second flexible beams have a first slit provided between the X-axis resistive element and the Z-axis resistive element, and has a second slit provided at an opposite side of the X-axis resistive element with respect to the first slit and a third slit provided at an opposite side of the Z-axis resistive element with respect to the first slit.

6. The acceleration sensor as set forth in claim 5, wherein the first slit is provided with notches each protruded so as to be opposite to the X-axis resistive element and the Z-axis resistive element.

7. The acceleration sensor as set forth in claim 5, wherein the second slit is provided with a notch protruded so as to be opposite to the X-axis resistive element.

8. The acceleration sensor as set forth in claim 5, wherein the third slit is provided with a notch protruded so as to be opposite to the Z-axis resistive element.

9. The acceleration sensor as set forth in claim 4, wherein the Z-axis resistive elements formed on the first flexible beam and the second flexible beam are disposed at one side on one beam and the other side on another beam, based on the X-axis resistive element.

10. An acceleration sensor, comprising:
a mass body;
a flexible beam that is provided with a piezoresistive element configured of an X-axis resistive element, a Y-axis resistive element, and a Z-axis resistive element having both ends connected with contact pads and is connected with the mass body; and
a support portion that is connected with the flexible beam and supports the flexible beam so as to float the mass body,
wherein the flexible beam has slits provided between one axis resistive element and the other axis resistive element that are adjacent to each other and the slit is provided between a contact pad of the one axis resistive element and a contact pad of the other axis resistive element opposite to the one axis resistive element.

11. The acceleration sensor as set forth in claim 10, wherein the flexible beam is configured of a first flexible beam, a second flexible beam, a third flexible beam, and a fourth flexible beam that are connected with all sides of the mass body at an equal distance, and
the first flexible beam and the second flexible beam are disposed to face each other based on the mass body and the third flexible beam and the fourth flexible beam are disposed so as to face each other based on the mass body.

12. The acceleration sensor as set forth in claim 11, wherein the first flexible beam and the second flexible beam are provided with the X-axis resistive element and the Z-axis resistive element and the third flexible beam and the fourth flexible beam are provided with the Y-axis resistive element.

13. The acceleration sensor as set forth in claim 12, wherein a width center of the first flexible beam that is an orthogonal direction to a direction in which the support portion is connected with the mass body is provided with the X-axis resistive element and a width edge of the first flexible beam is provided with the Z-axis resistive element so as to be parallel with the X-axis resistive element, and
a width center of the second flexible beam that is an orthogonal direction to a direction in which the support portion is connected with the mass body is provided the X-axis resistive element and a width edge of the second flexible beam is provided with the Z-axis resistive element so as to be parallel with the X-axis resistive element.

14. The acceleration sensor as set forth in claim 13, wherein the Z-axis resistive elements formed on the first flexible beam and the second flexible beam are disposed at one side on one beam and the other side on another beam, based on the X-axis resistive element.
